(19) United States
(12) Patent Application Publication
(10) Pub. No.: US 2021/0011166 A1
(43) Pub. Date: Jan. 14, 2021

(54) SYSTEM, APPARATUS, AND METHOD FOR IMPROVING PERFORMANCE OF IMAGING LIDAR SYSTEMS

(71) Applicant: METRIO SENSORS INC., Vancouver (CA)

(72) Inventor: Robert HANNEBAUER, Vancouver (CA)

(21) Appl. No.: 16/970,720

(22) PCT Filed: Mar. 13, 2019
(86) PCT No.: PCT/CA2019/000036

§ 371 Date: Aug. 18, 2020

Related U.S. Application Data
(60) Provisional application No. 62/643,171, filed on Mar. 15, 2018.

(51) Int. Cl. G01S 17/89; G01S 7/481; G01S 17/10; G01S 7/484; G01S 7/4865

(52) U.S. Cl. CPC G01S 17/89; G01S 7/4815; G01S 7/4865; G01S 7/484; G01S 17/10

(57) ABSTRACT

A system for three-dimensional range mapping of an object or objects is provided, the system comprising: a Light Detection and Ranging (LIDAR) system, the LIDAR system including an array of light beam emitters, at least one detector element, and a computational unit, the computational unit configured to: instruct the light beam emitters to simultaneously emit emitted light beams; embed ranging information in the emitted light beams; identify each emitted light beam with a unique orthogonal waveform; auto-correlate the unique orthogonal waveform in each reflected beam received at each detector element with the unique orthogonal waveforms in the emitted light beams to provide emitted and reflected light beam pairs; determine a time of flight for each emitted and reflected light beam pair; and determine a range from the time of flight.

### CROSS REFERENCE TO RELATED APPLICATIONS

The present invention claims the benefit of U.S. Patent Application Ser. No. 62/643,171, filed on Mar. 15, 2018 and entitled SYSTEM, APPARATUS, AND METHOD FOR IMPROVING PERFORMANCE OF IMAGING LIDAR SYSTEMS, which is hereby incorporated in its entirety including all tables, figures, and claims.

### FIELD

The present technology is directed to a Light Detection and Ranging system in which multiple light sources can emit beams simultaneously and be discriminated between. More specifically, it is a system in which each beam is encoded with a code that is specific to the beam, which upon returning to the system, is autocorrelated and the beam identified in order to calculate time of flight for the beam and determine range.

### BACKGROUND

LIDAR (Light Detection and Ranging) is a remote sensing method that uses light in the form of a pulsed laser to measure ranges (variable distances) to objects. An imaging LIDAR system is one in which there is a range image obtained from objects in the field of view of the LIDAR. This system composes an image that is very much like a typical image or picture, but instead of having a light intensity value in the array of values presented, the distance away from the LIDAR system are the values present. The primary focus of some LIDAR systems is for ADAS (Advanced Driver Assistance System) used for vehicle collision avoidance, navigation and safety systems that determine the distance of objects away from a vehicle.

ADAS's have various configurations. One such type is as a scanned system which functions by creating a horizontal fan-shaped beam of light from a plurality of laser light sources that switch on and off in a temporal sequence. The sequence of horizontal fan-shaped beams of light scans vertically across a scene. The time between when a probe laser beam is emitted and a reflected laser beam is received at the receiver after having reflected off an object located within a scene is measured and is proportional to the distance between the reflecting object and the LIDAR system. One of the main drawbacks to this system is that the reflected laser beams are received at different times due to the sequential scanning and hence the range information across the scene is acquired at different times. This non-concurrency can lead to inaccurate results, incorrect predictions of movement within the scene and distortions of objects (leading to misidentification).

Other systems apply wavelength division multiplexing by employing laser light sources of different wavelengths. This system requires the receiver being able to discriminate between the different laser light sources based upon wavelength, which in turn dictates the need for a single detector per wavelength along with discriminating filters. This is an increase in the complexity of the optical configuration.

U.S. Pat. No. 7,969,558 discloses a LIDAR-based 3-D point cloud measuring system and method. An example system includes a base, a housing, a plurality of photon transmitters and photon detectors contained within the housing, a rotary motor that rotates the housing about the base, and a communication component that allows transmission of signals generated by the photon detectors to external components. The rotary component includes a rotary power coupling configured to provide power from an external source to the rotary motor, the photon transmitters, and the photon detectors. In another embodiment, the photon transmitters and detectors of each pair are held in a fixed relationship with each other. In yet another embodiment, a single detector is “shared” among several lasers by focusing several detection regions onto a single detector, or by using a single, large detector. In this system, lasers must emit one at a time in order to ensure that there is no ambiguity with regard to which laser is emitting. There is no autocorrelation. There is teaching away from the use of “flash LIDAR” stating that there are problems associated with it including the need for a 2-dimensional focal plane array.

United States Patent Application 20130044310 discloses a system and method for detecting a distance to an object. The method comprises providing a lighting system having at least one pulse width modulated visible-light source for illumination of a field of view; emitting an illumination signal for illuminating the field of view for a duration of time y using the visible-light source at a time t; integrating a reflection energy for a first time period from a time t−x to a time t+x; determining a first integration value for the first time period; integrating the reflection energy for a second time period from a time t+y−x to a time t+y+x; determining a second integration value for the second time period; calculating a difference value between the first integration value and the second integration value; determining a propagation delay value proportional to the difference value; determining the distance to the object from the propagation delay value. In this system, lasers must emit one at a time in order to ensure that there is no ambiguity with regard to which laser is emitting. There is no autocorrelation to enable simultaneous reception.

United States Patent Application 20170090031 discloses a system, a method and a processor-readable medium for spatial profiling. In one arrangement, the described system includes a light source configured to provide outgoing light having at least one time-varying attribute at a selected one of multiple wavelength channels, the at least one time-varying attribute includes either or both of (a) a time-varying intensity profile and (b) a time-varying frequency deviation, a beam director configured to spatially direct the outgoing light into one of multiple directions in two dimensions into an environment having a spatial profile, the one of the multiple directions corresponding to the selected one of the multiple wavelength channels, a light receiver configured to receive at least part of the outgoing light reflected by the environment, and a processing unit configured to determine at least one characteristic associated with the at least one time-varying attribute of the reflected light at the selected one of the multiple wavelengths for estimation of the spatial profile of the environment associated with the corresponding one of the multiple directions. The focus of this technology is suppression of unwanted signals from the environment. The approach disclosed requires an increase in complexity and cost in relation to existing systems. In this system, lasers must emit one at a time in order to ensure that there is no ambiguity with regard to which laser is emitting. There is no autocorrelation to enable simultaneous reception.

What is needed is a system and method to improve the performance of LIDAR systems. It would be preferable if the system improved range resolution and range update rate, while employing existing LIDAR electro-optical systems. It would be even more preferable if the laser light sources were operated simultaneously, resulting in the range information from the reflected light beams being acquired simultaneously. It would be further preferable if the system discriminated between the reflected beams. It would also be preferable if the system and method improved local velocity flow estimation, reduced power consumption, and increased eye safety of the laser light sources in the optical set-up of an ADAS. It would be most preferable if there was a correlational based scheme that reduces opto-electronic complexity and the number of components.

### SUMMARY

The present technology is a system and method that improves the performance of existing LIDAR systems. The system improves range resolution and range update rate, while using existing LIDAR electro-optical systems. In one instance the laser light sources in the system are arranged in a vertical array and operate simultaneously, resulting in the range information from the reflected light beams being acquired simultaneously. The system discriminates between the incoming reflected beams. The system and method improve local velocity flow estimation, reduced power consumption, and increase eye safety of the laser light sources in the optical set-up of an ADAS. The present technology is a correlational based scheme that reduces opto-electronic complexity and the number of components.

In one embodiment, a system for three-dimensional range mapping of an object or objects is provided, the system comprising: a Light Detection and Ranging (LIDAR) system, the LIDAR system including an array of light beam emitters, at least one detector element, and a computational unit, the computational unit configured to: instruct the light beam emitters to simultaneously emit emitted light beams; embed ranging information in the emitted light beams; identify each emitted light beam with a unique orthogonal waveform; auto-correlate the unique orthogonal waveform in each reflected beam received at each detector element with the unique orthogonal waveforms in the emitted light beams to provide emitted and reflected light beam pairs; determine a time of flight for each emitted and reflected light beam pair; and determine a range from the time of flight.

In the system, the unique orthogonal waveform may be a Hadamard code.

In the system, the embedded ranging information may be a pseudo-noise (PN) pulse train.

In the system, the PN pulse train may be transformed with the Hadamard code.

In the system, the computational unit may include a correlator for each light beam emitter, the correlator configured to auto-correlate the unique orthogonal waveform in each reflected beam received at each detector element with the unique orthogonal waveforms in the emitted light beams.

In the system, the light beam emitters may be laser light beam emitters.

In another embodiment, a system for three-dimensional range mapping of an object or objects is provided, the system comprising: computing device including a microprocessor, a timer, the timer configured to determine a time of flight, and a memory, the memory configured to instruct the microprocessor; an array of light sources under control of the microprocessor and configured to emit a plurality of emitted beams; a ranging information embedder under control of the microprocessor, the ranging information embedder configured to embed the plurality of emitted beams; a plurality of orthogonal waveform generators under control of the microprocessor, and configured to embed the plurality of emitted beams, a specific orthogonal waveform generator associated with a specific light source, such that a specific emitted beam is embedded with a specific orthogonal waveform; a plurality detector elements configured to receive a plurality of focused beams; and a plurality of correlators under control of the microprocessor and configured to correlate a specific received beam with a specific emitted beam, each correlator corresponding to each light source and in communication with the timer.

In the system, the orthogonal waveform generators may be Hadamard generators.

In the system, the ranging information embedder may be a PN pulse train generator.

In the system, the array of light sources may be a linear array.

In the system, the linear array may be a vertical linear array.

In the system, wherein the light beam emitters may be laser light beam emitters.

In the system, the detector elements may be in a horizontally disposed detector.

In another embodiment, a computational unit for use with a LIDAR system is provided, the LIDAR system including an array of light beam emitters and at least one detector element, the computational unit configured to: instruct each light beam emitter in the array of light beam emitters to simultaneously emit an emitted light beam; embed each emitted light beam with a ranging information; identify each emitted light beam with a unique orthogonal waveform; match the unique orthogonal waveform in each reflected beam with the unique orthogonal waveform in the emitted light beam; and determine a range from a time of flight for each emitted and reflected light beam pair.

In another embodiment, a system for three-dimensional range mapping of an object or objects is provided, the system comprising: a LIDAR system, the LIDAR system including an array of light beam emitters, each which emit a transmission signal, at least one detector element for receiving reception signals, a circuit control block, a transmitting computational unit, which is under control of the circuit control block and a receiving computational unit which is under control of the circuit control block, the transmitting computational unit configured to instruct the light beam emitters to simultaneously emit a transmission signal and to embed the transmission signals with ranging information, the transmitting computational unit including a specific computational system for each light beam emitter, the receiver computational system configured to identify each transmission signal with a unique orthogonal waveform; match the unique orthogonal waveform in each reception signal to the unique orthogonal waveform in the transmission signal; and determine a range from a time of flight for each transmission and reception pair.

In the system, the transmitting computational unit may include a PN pulse train generator to embed the emitted light beams with ranging information.

In the system, the computational system may include Hadamard generators to identify the transmission signal with the unique orthogonal waveform.

In another embodiment, a method of three-dimensional range mapping of an object or objects is provided, the method comprising: selecting a LIDAR system, the LIDAR system including an array of light beam emitters, each which emit a transmission signal, at least one detector element for receiving reception signals, and a computational unit, the computational unit including a specific computational system for each light beam emitter, the computational unit:

instructing the light beam emitters to simultaneously emit a transmission signal;

embedding the transmission signals with ranging information;

identifying each transmission signal with a unique orthogonal waveform;

matching the unique orthogonal waveform in each reception signal to the unique orthogonal waveform in the transmission signal;

and determining a range from a time of flight for each transmission and reception signal pair.

In the method, the embedding ranging information may be embedding a pseudo-noise (PN) pulse train.

In the method, the identifying each transmission signal with a unique orthogonal waveform may comprise identifying each transmission signal with a unique Hadamard code.

The method may comprise transforming the PN pulse train with the Hadamard code.

In an embodiment of a system with multiple lasers in an array, the system:
Assigns a unique identifier to each laser to be emitted from array of lasers;
Emits multiple lasers simultaneously from the array, each laser containing a unique identifier through encoding (transmission). The lasers impinge upon an object and reflect back toward the device containing the array and system;
Receives signals associated with each transmission signal, simultaneously (reception);
Differentiates each signal based on unique identifier assigned to each signal at transmission;
Measures time delay between each unique signal's transmission and reception at the device containing the system and array;
Determines distance of object based on the time delay between all transmission and reception signals discriminated by the use of identifiers.

### FIGURES

FIG. 1 is a schematic of an aspect of the optical system of the present technology showing light emission.

FIG. 2 is a schematic of an aspect of the optical system of the present technology showing light reception.

FIG. 3 is a schematic showing the linear array of laser emitters and the diverging lens, showing light transmission and reflection.

FIG. 4 is a schematic showing the focusing lens and the linear array detector.

FIG. 5 is a schematic showing the transmission components of the computational unit.

FIG. 6A is a schematic showing a block diagram of the operation of the computational unit during transmission and the components acted upon during transmission; FIG. 6B is a schematic showing a block diagram of the operation of the computational unit during reception and the components acted upon during reception.

FIG. 7 is a block diagram showing the steps in reception of the light beams and autocorrelation.

FIG. 8 is a diagram of an individual PN sequence PN pulse train.

FIG. 9 is a block diagram showing the steps in encoding and transmitting the light beams.

FIG. 10 is a schematic showing the reception components of the computational unit.

FIG. 11 is a block diagram showing the steps of the method of determining range and time of flight.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

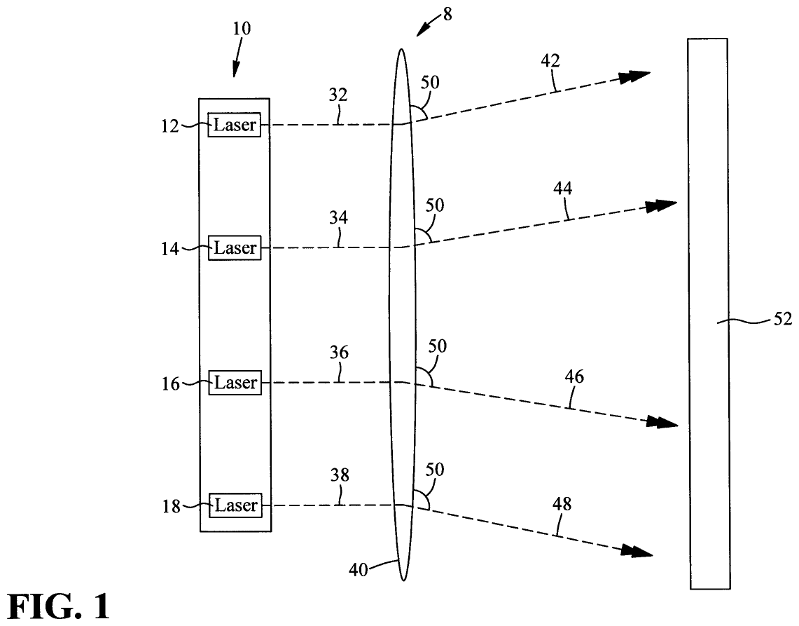

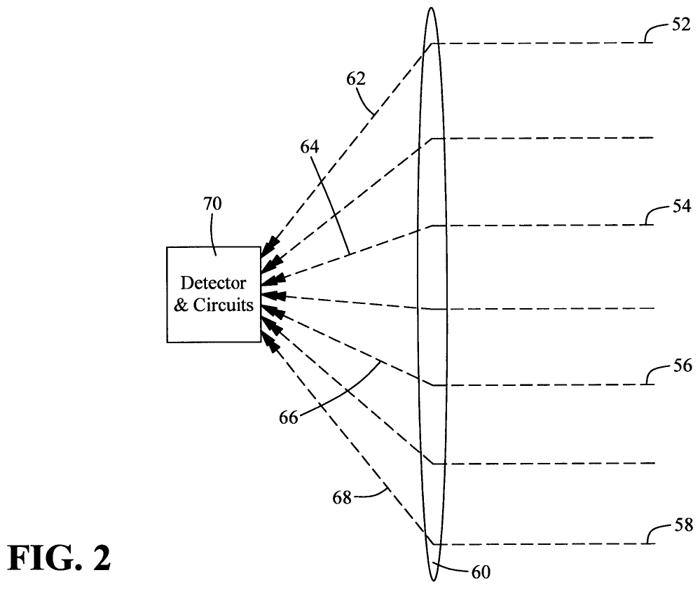

An optical system, generally referred to as 8 includes an exemplary linear array, generally referred to as 10, of light sources 12, 14, 16, 18 is shown in FIG. 1. While four light sources are shown, there can be a plurality of light sources. The light sources can be, for example, but not limited to laser light sources or light emitting diodes. Each light source 12, 14, 16, 18 emits an emitted beam 32, 34, 36, 38 which passes through a diverging lens 40 and creates planar, horizontal fan-shaped probe beams 42, 44, 46, 48 (referred to as probe beams). In an embodiment, the linear array 10 is a vertical linear array. The light sources 12, 14, 16, 18 are positioned in relation to the diverging lens 40 such that each emitted beam 32, 34, 36, 38 is refracted at a different angle 50 to the others in the array 10, resulting in each probe beam 42, 44, 46, 48 striking a different part of an object 52. As shown in FIG. 2, reflected beams 52, 54, 56, 58 from the object 52 pass through a focusing lens 60 where they are focused to focused beams 62, 64, 66, 68, which then strikes a detector 70. An embodiment of the focusing lens is an astigmatic optical system. The reflected beams 52, 54, 56, 58 and the focused beams 62, 64, 66, 68 are planar horizontal fan-shaped beams.

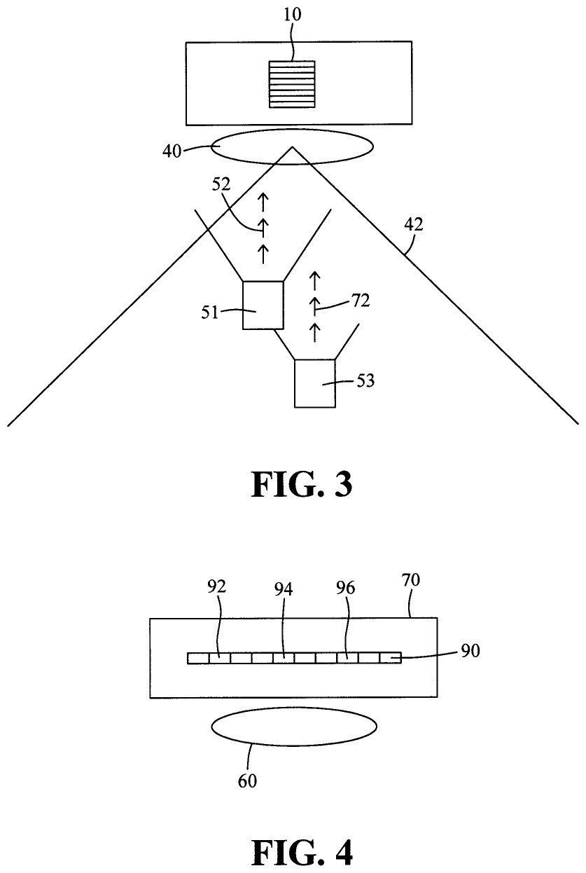

As shown in FIG. 3, using one probe beam as an example, the probe beam 42 is reflected off the first objects 51 to become the first reflected beam 52 (54, 56, 58 are the reflected beams corresponding to probe beams 42, 44, 46, 48, but are omitted from the drawing for clarity—in reality there are multiple reception signals (which includes the reflected beams and the focused beams) all focused on one detector element 92 in a confusion of reception signals of the various ranges from various elevations. The probe beam 42 is reflected off the second object 53 to become the second reflected beam 72 (74, 76, 78 are the second reflected beams corresponding to probe beams 42, 44, 46, 48, but are omitted from the drawing for clarity). The first object 52 is closer to the linear array 10 than the second object 53, hence the time of flight for the for the first reflected beam 52 is shorter than the time of flight for the second reflected beam 72.

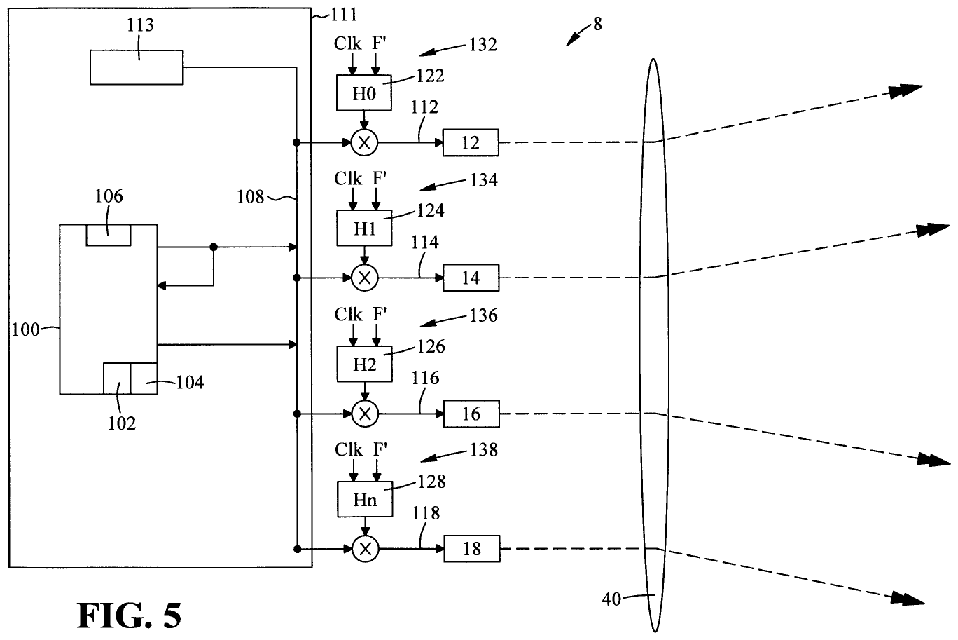

The detector 70 is shown in FIG. 4. The receiving optics are configured to accept the horizontal fan-shaped beams, as it has a horizontally aligned linear array, generally referred to as 90 of detector elements 92, 94, 96. Three detector elements are shown in FIG. 4, however, one skilled in the art would understand that there can be many more than three. The detector 70 receives beams from any vertical extent and maps them onto the linear array 90 such that regardless of the vertical displacement of the probe beam, the focused beam will always be incident on the detector 70. Horizontal location is-distinct because there are detector elements 92, 94, 96 at each horizontal position and lens 60 images the reflected light off of objects onto the array 90.

The combination of vertical positioning of the linear array 10 of light sources 12, 14, 16, 18 and horizontal discrimination in the detector 70 with its linear array 90 of detector elements 92, 94, 96 allows one to compute a two-dimensional array of range values. Because the light sources operate simultaneously, the two-dimensional array of range values are acquired simultaneously.

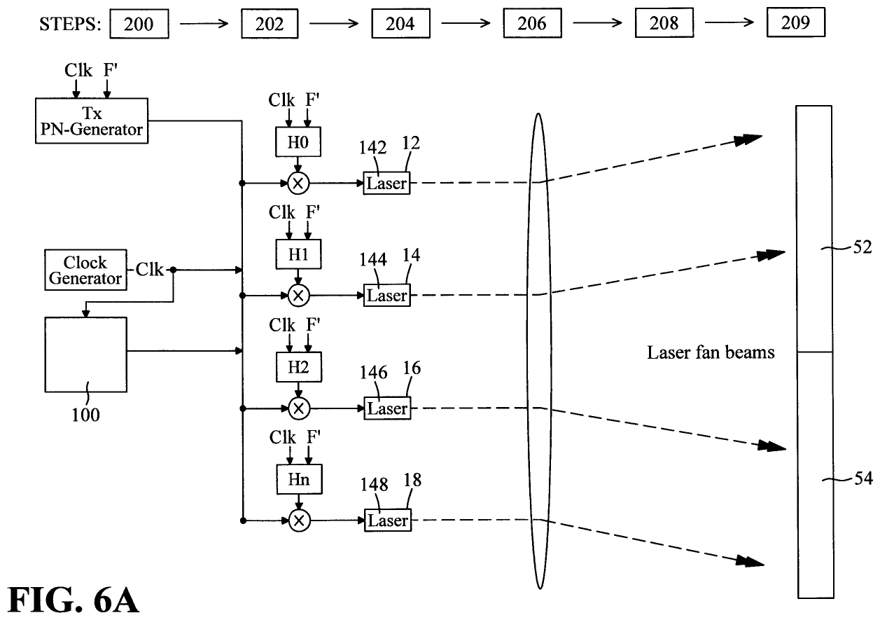

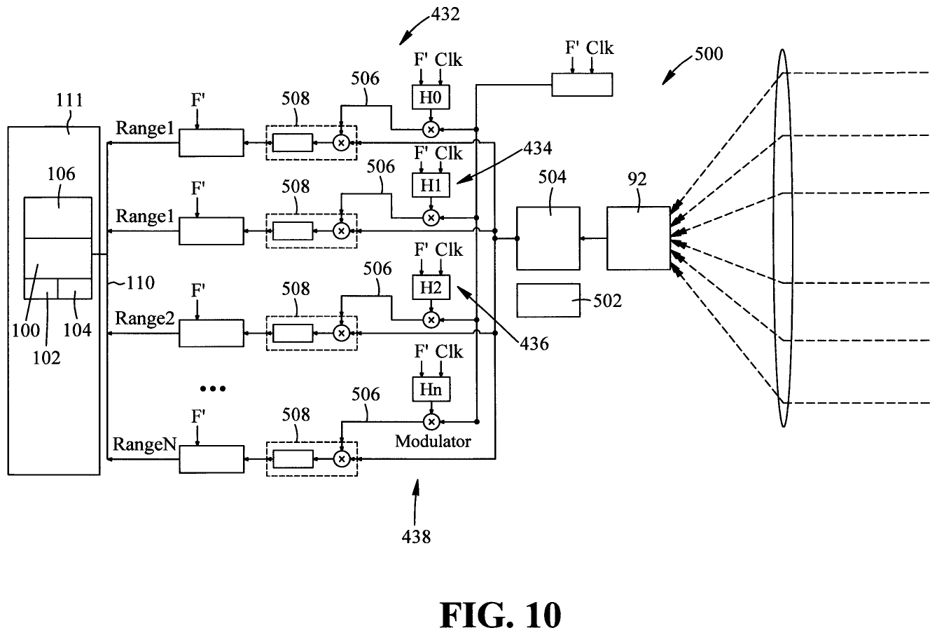

FIG. 5 shows the transmitter components of the optical system 8. It includes a control circuit block 111 and the transmitting computational units 132, 134, 136, 138, which are all the elements in the drawing excluding the light sources 12, 14, 16, 18 and the lens 40. The control circuit block 111 includes a computing device 100 which may be a silicon chip or a field-programmable gate array (FPGA). The computing device 100 may include a microprocessor 102 and a memory 104, which is configured to instruct the microprocessor 102. The computing device 100 also includes a clock generator 106 which is in electrical communication with the transmitter line 108 and the receiver line 110 (see FIG. 10), which are in the control circuit block 111. The control circuit block 111 controls the transmitting computational units 132, 134, 136, 138 and coordinates the transmitter line 108 and the receiver line 110. The control circuit block 111 emits the signal F′ that controls the frame timing and frame update rate. A ranging information embedder such as a transmit pseudo-noise generator 113 is in electrical communication with the transmitter circuit 108. It produces pseudo-noise (PN) pulse train. The transmitter circuit 108 splits into discrete channels 112, 114, 116, 118, with there being one channel for each laser light emitter 12, 14, 16, 18. Each channel 112, 114, 116, 118 has a Hadamard-code generator 122, 124, 126, 128 that generate a specific (unique) orthogonalizing Hadamard codes to ensure that each laser pulse train is separable from its neighbor. The channels 112, 114, 116, 118 terminate at the light sources 12, 14, 16, 18. The family of Hadamard codes are used to modulates the PN code and the subsequent pulse trains are used to drive the light sources 12, 14, 16, 18 which emit the encoded signals, thus creating simultaneously transmitted but specifically (uniquely) encoded emitted beams 32, 34, 36, 38.

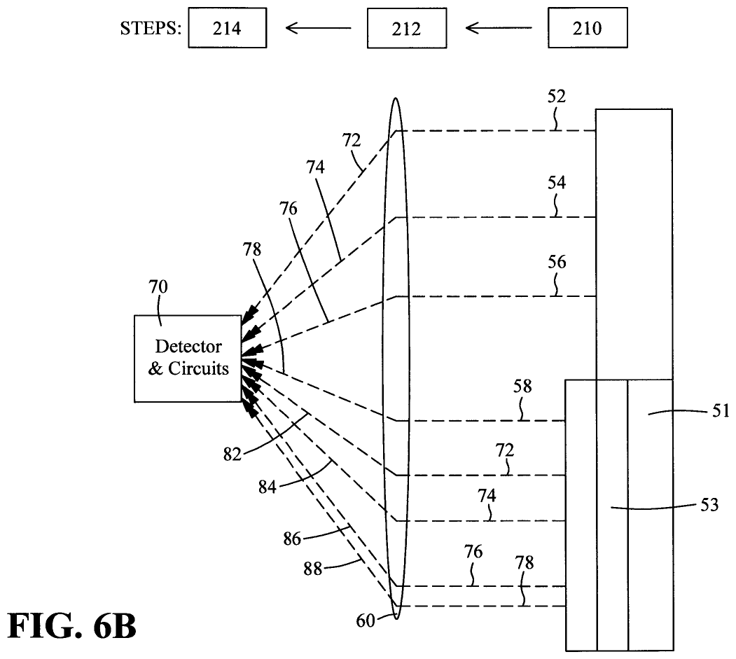

As shown in FIG. 6A, the Hadamard code generator 122, 124, 126, 128, when instructed 200 by the memory 104, encodes 202 each emitted beam 32, 34, 36, 38 with a beam-specific orthogonalized code 142, 144, 146, 148. These are specific identifiers associated with a given light source 12,14,16,18. The emitted beams 32, 34, 36, 38 are simultaneously emitted 204 from their respective light sources 12,14,16,18. The emitted beams 32, 34, 36, 38 strike 206 the lens 40 and are transmitted 208 as probe beams 42, 44, 46, 48, which strike 209 objects 52, 54. As shown in FIG. 6B, the probe beams 24, 44 26 48 are reflected 210 as reflected beams 52, 54, 56, 58. The reflected beams 52, 54, 56, 58 are focused 212 by the lens 60 into focused beams 62, 64, 66, 68 and are received 214 by the detector 70. The specific code or modulation 142, 144, 146, 148 remains 206 encoded in the probe beams 42, 44, 46, 48, the reflected beams 52, 54, 56, 58, the second reflected beams 72,74, 76, 78, the focused beams 62, 64, 66, 68, and the second focused beams 82, 84, 86, 88. As would be known to one skilled in the art, there will be many reflected beams and many focused beams. The present disclosure is only exemplary and is referencing beams reflected from two different objects for clarity. In one embodiment the codes generated are comprised of maximal sequence length pseudo-noise codes orthogonalized with Walsh/Hadamard codes (henceforth called a “code”) to generate a family of codes (henceforth called a “codebook”) as a complete collection.

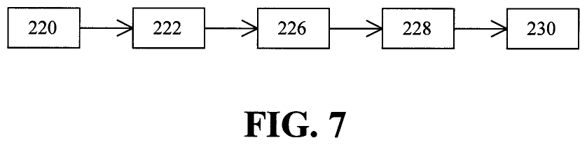

As shown in FIG. 7, the microprocessor 102 is instructed 220 by the memory 104 to extract 222 the specific code or modulation 142, 144, 146, 148 from the specific focused beams 62, 64, 66, 68, match (auto correlate) 224 the specific code or modulation 142, 144, 146, 148 from the specific focused beam 62, 64, 66, 68 with the specific code or modulation 142, 144, 146, 148 from the probe beams 42, 44, 46, 48 and differentiate 226 between the pairs of transmission (emitted beams 32, 34, 36, 38) and reception signals (focused beams 62, 64, 66, 68). The microprocessor 102 is instructed by the memory 104 to determine 228 the time of flight for each pair of transmission and reception signals and to gather 230 range information. To be clear, the Hadamard generator encodes emitted beam 32 with code 142. The code 142 returns in the focused beam 62, Hadamard generator encodes emitted beam 34 with code 144. The code 144returns in the focused beam 62. The correlator auto-correlates code 142 that encoded the emitted beam 32 with code 142 in the focused beam 62. The correlator auto-correlates code 144 that encoded the emitted beam 34 with code 144 in the focused beam 64. This occurs for each beam being transmitted and received.

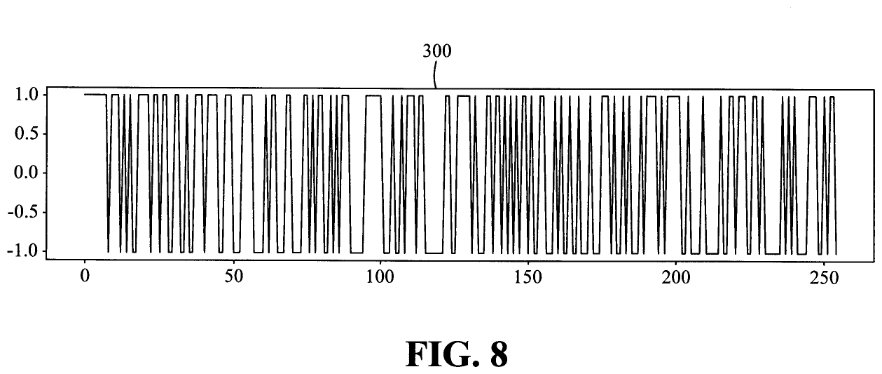

The details of the modulation and demodulation can be understood from FIGS. 7 and 8. In FIG. 8 an individual PN sequence PN pulse train 300, which is 256 pulses long is shown. The −1 representation is when the light source is off.

Walsh/Hadamard codes have lengths that are an even power of 2, for example 2^{N}. PN m-sequences have lengths as a power of 2^{N}-1. An additional “Zero” or off state is inserted into the m-sequence at the location of the longest run of zeros in the code sequence to bring the length of this “padded” m-sequence up to a length of 2^{N}.

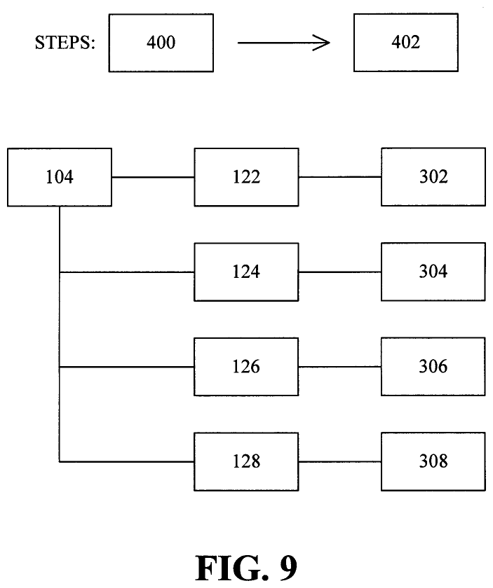

As shown in FIG. 9, the Hadamard code generator 122, 124, 126, 128 is instructed by the memory 104 to encode 400 the PN sequence 300 with a Hadamard transform to provide 402 a Hadamard transform encoded PN sequence 302, 304, 306, 308. Each emitted beam 32, 34, 36, 38 is encoded 402 with a distinct Hadamard transform encoded PN sequence 302, 304, 306, 308. The Hadamard transform allows individual emitted beam 32, 34, 36, 38 to be modulated by different waveforms. One of the uses of a PN sequence is in ranging applications, thus by applying a Hadamard transform encoded PN sequence 302, 304, 306, 308 with distinct Hadamard codes to each of the emitted beam 32, 34, 36, 38, the transmission signals and reception signals are sent with embedded ranging information. The system 8 can simultaneously send transmission signals and receive reception signals.

Another benefit of using PN codes is a factor called process gain; process gain arises from the fact that under the demodulation scheme one is reconstructing multiple samples over time in the demodulator that is a correlator. This demodulation scheme emphasizes only specific patterns and gives them gain (through summation in the correlator) that is associated with the processing of the signal thus it is called processing gain. Because of this process gain, the emitted beam 32, 34, 36, 38 can be reduced by a significant amount, thus reducing the total transmitted power of all the light sources 12, 14, 16, 18 rendering it more eye-safe while consuming less power.

In one implementation, there is an inherent pulse repetition rate and an intrinsic dwell time as the reception signal is timed for the time-of-flight ranging information. By implementing the system 8 with the same inherent pulse repetition rate but with more pulses in the Hadamard encoded PN sequences, a higher resolution of the range information is achieved. A longer encoded PN sequence also provides a better estimate of the ranging.

FIG. 10 shows the receiver components of the receiver computational units 432, 434, 436, 438 of the optical system 8. Using detector element 92 as an example, there is a discrete detector circuit (computational system) 500 for each detector element 92, 94, 96 (to be clear, the detector elements are not part of the receiver computational units 432, 434, 436, 438). The detector circuit 500 is in communication with a TIA (Transimpedance amplifier) 502 (which is not part of the computational unit) and individual correlator channels 506, each with their sliding correlator 508. The TIA ensures high-speed operation. The sliding correlator 508 is in electronic communication with the Hadamard code generator 122, 124, 126, 128.

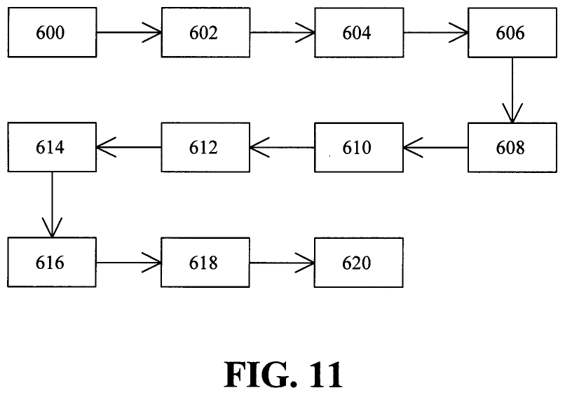

The steps of the method of determining range and time of flight is shown in FIG. 11. The detector detects 600 a plurality of focused beams and sends 602 an analogue signal to the analog to digital converter which digitizes 604 the signal. The digitized signal is replicated 606 into the individual correlator channels. This is because each detector element receives focused beams from any one or more of the lasers, so in order to identify which laser it came from, the system needs to compare the incoming code with the outgoing codes. In each correlator channel the Hadamard code and PN code is used to identify 608 the laser from which the beams were first emitted. They are also used to obtain ranging information. The PN and Hadamard codes are self-correlating mathematical structures (they are their own inverse). This comprises the sliding correlator. If the codes are aligned 610, the sliding correlator emits 612 a pulse that indicates there is code alignment. If the codes are misaligned 614, then a direct measure of the time of flight is provided 616 and range is directly determined 618. Range is emitted 620 from each of the timing comparison blocks after each correlator.

In an alternative embodiment, encoding the emitted beams is effected using any family of waveforms that are individually noise like, individually strongly auto-correlate and do not cross correlate (or are orthogonal)with other family members, for example, but not limited to Kasami sequences and Golay binary complementary sequences.

In an alternative embodiment, the array of light sources is not a linear array. Similarly, in an alternative embodiment, the array of detector elements is not in a detector. In another embodiment, the array of detector elements and the detector may not be in a linear array, for example, but not limited, a circular arrangement, a rotating array or a sphere of detector elements.

### EXAMPLE 1

### Spatial Profiling for ADAS

The primary focus of some LIDAR systems is for ADAS (Advanced Driver Assistance System) used for vehicle collision avoidance, navigation and safety systems that determine the distance of objects away from a vehicle. The present system is integrated into existing systems, for example, but not limited to the system disclosed in US Patent Application 20170090031. The present system overcomes the deficiencies in US Patent Application 20170090031, as it reduces the complexity of the system and allows for simultaneous emission of light beams as a result of the autocorrelation capability. The estimation of the spatial profile of an environment as seen from one or more particular perspectives, by determining the distance of any reflecting surface, such as that of an object or obstacle, within a solid angle or field of view for each perspective. The described system may be useful in monitoring relative movements or changes in the environment.

In the field of autonomous vehicles (land, air, water, or space), the present system, integrated into existing systems can estimate from the vehicle's perspective a spatial profile of the traffic conditions, including the distance of any objects, such as an obstacle or a target ahead. As the vehicle moves, the spatial profile as viewed from the vehicle at another location may change and may be re-estimated. As another example, in the field of docking, the system can estimate from a ship's perspective a spatial profile of the dock, such as the closeness of the ship to particular parts of the dock, to facilitate successful docking without collision with any parts of the dock.

### EXAMPLE 2

### Spatial Profiling for Task Automation

The present system is integrated into existing systems, for example, but not limited to the system disclosed in US Patent Application 20130044310. The present system overcomes the deficiencies in US Patent Application 20130044310, as it reduces the complexity of the system and allows for simultaneous emission of light beams as a result of the autocorrelation capability. The present system, integrated into an existing system, can be used in the fields of industrial measurements and automation, site surveying, military, safety monitoring and surveillance, robotics and machine vision.

### EXAMPLE 3

### Spatial Profiling for Environmental Monitoring

The present system is integrated into existing systems, for example, but not limited to the system disclosed in U.S. Pat. No. 7,969,558. The present system overcomes the deficiencies in U.S. Pat. No. 7,969,558 as a result of the autocorrelation capability. The present system, integrated into an existing system, can be used in the fields Agriculture and Precision Forestry, Civil Engineering and Surveying, Defense and Emergency Services, Environmental and Coastal Monitoring, Highways and Road Networks, Mining, Quarries and Aggregates, Rail Mapping and Utilities.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A system for three-dimensional range mapping of an object or objects, the system comprising: a Light Detection and Ranging (LIDAR) system, the LIDAR system including an array of light beam emitters, at least one detector element, and a computational unit, the computational unit configured to: instruct the light beam emitters to simultaneously emit emitted light beams; embed ranging information in the emitted light beams; identify each emitted light beam with a unique orthogonal waveform; auto-correlate the unique orthogonal waveform in each reflected beam received at each detector element with the unique orthogonal waveforms in the emitted light beams to provide emitted and reflected light beam pairs; determine a time of flight for each emitted and reflected light beam pair; and determine a range from the time of flight.

2. The system of claim 1, wherein the unique orthogonal waveform comprises a Hadamard code.

3. The system of claim 1 or 2, wherein the embedded ranging information comprises a pseudo-noise (PN) pulse train.

4. The system of claim 3, wherein the PN pulse train is transformed with the Hadamard code.

5. The system of any one of claims 1 to 4, wherein the computational unit includes a correlator for each light beam emitter, the correlator configured to auto-correlate the unique orthogonal waveform in each reflected beam received at each detector element with the unique orthogonal waveforms in the emitted light beams.

6. The system of any one of claims 1 to 5, wherein the light beam emitters comprise laser light beam emitters.

7. A system for three-dimensional range mapping of an object or objects, the system comprising: computing device including a microprocessor, a timer, the timer configured to determine a time of flight, and a memory, the memory configured to instruct the microprocessor; an array of light sources under control of the microprocessor and configured to emit a plurality of emitted beams; a ranging information embedder under control of the microprocessor, the ranging information embedder configured to embed the plurality of emitted beams; a plurality of orthogonal waveform generators under control of the microprocessor, and configured to embed the plurality of emitted beams, a specific orthogonal waveform generator associated with a specific light source, such that a specific emitted beam is embedded with a specific orthogonal waveform; a plurality detector elements configured to receive a plurality of focused beams; and a plurality of correlators under control of the microprocessor and configured to correlate a specific received beam with a specific emitted beam, each correlator corresponding to each light source and in communication with the timer.

8. The system of claim 7, wherein the orthogonal waveform generators comprise Hadamard generators.

9. The system of claim 7 or 8, wherein the ranging information embedder comprises a PN pulse train generator.

10. The system of any one of claims 7 to 9, wherein the array of light sources comprise a linear array.

11. The system of claim 10, wherein the linear array comprise a vertical linear array.

12. The system of any one of claims 7 to 11, wherein the light beam emitters comprise laser light beam emitters.

13. The system of any one of claims 7 to 12, wherein the detector elements are in a horizontally disposed detector.

14. A computational unit for use with a LIDAR system, the LIDAR system including an array of light beam emitters and at least one detector element, the computational unit configured to: instruct each light beam emitter in the array of light beam emitters to simultaneously emit an emitted light beam; embed each emitted light beam with a ranging information; identify each emitted light beam with a unique orthogonal waveform; match the unique orthogonal waveform in each reflected beam with the unique orthogonal waveform in the emitted light beam; and determine a range from a time of flight for each emitted and reflected light beam pair.

15. A system for three-dimensional range mapping of an object or objects, the system comprising: a LIDAR system, the LIDAR system including an array of light beam emitters, each which emit a transmission signal, at least one detector element for receiving reception signals, a circuit control block, a transmitting computational unit, which is under control of the circuit control block and a receiving computational unit which is under control of the circuit control block, the transmitting computational unit configured to instruct the light beam emitters to simultaneously emit a transmission signal and to embed the transmission signals with ranging information, the transmitting computational unit including a specific computational system for each light beam emitter, the receiver computational system configured to identify each transmission signal with a unique orthogonal waveform; match the unique orthogonal waveform in each reception signal to the unique orthogonal waveform in the transmission signal; and determine a range from a time of flight for each transmission and reception pair.

16. The system of claim 15, wherein the transmitting computational unit includes a PN pulse train generator to embed the emitted light beams with ranging information.

17. The system of claim 15 or 16, wherein the computational system includes Hadamard generators to identify the transmission signal with the unique orthogonal waveform.

18. A method of three-dimensional range mapping of an object or objects, the method comprising: selecting a LIDAR system, the LIDAR system including an array of light beam emitters, each which emit a transmission signal, at least one detector element for receiving reception signals, and a computational unit, the computational unit including a specific computational system for each light beam emitter, the computational unit:
instructing the light beam emitters to simultaneously emit a transmission signal;
embedding the transmission signals with ranging information;
identifying each transmission signal with a unique orthogonal waveform;
matching the unique orthogonal waveform in each reception signal to the unique orthogonal waveform in the transmission signal;
and determining a range from a time of flight for each transmission and reception signal pair.

19. The method of claim 18, wherein the embedding ranging information comprises embedding a pseudo-noise (PN) pulse train.

20. The method of claim 19, wherein the identifying each transmission signal with a unique orthogonal waveform comprises identifying each transmission signal with a unique Hadamard code.

21. The method of claim 20, comprising transforming the PN pulse train with the Hadamard code.
